(19) United States
(12) Patent Application Publication
(10) Pub. No.: US 2019/0248262 A1
(43) Pub. Date: Aug. 15, 2019

(54) METHOD FOR CONTROLLING MASSAGE UNITS OF A MASSAGE APPARATUS ARRANGED IN A SEAT, SEAT ARRANGEMENT FOR A VEHICLE OR IN A VEHICLE

(71) Applicant: BROSE FAHRZEUGTEILE GMBH & CO. KOMMANDITGESELLSCHA KOMMANDITGESELLSCHAFT, COBURG, Coburg (DE)

(72) Inventors: Christian MERGL, Zeil/Main (DE); Gregor KROENER, Bischberg (DE)

(73) Assignee: BROSE FAHRZEUGTEILE GMBH & CO. KOMMANDITGESELLSCHA KOMMANDITGESELLSCHAFT, COBURG, Coburg (DE)

(21) Appl. No.: 16/331,739

(22) PCT Filed: Sep. 7, 2017
(86) PCT No.: PCT/EP2017/072445

§ 371 Date: Mar. 8, 2019

(30) Foreign Application Priority Data
Sep. 8, 2016 (DE) 10 2016 217 124.0

(51) Int. Cl. B60N 2/90

(52) U.S. Cl. CPC B60N 2/976

(57) ABSTRACT

Method for controlling massage units of a massage apparatus arranged in a seat in a vehicle for massaging an occupant, comprising the following method steps: controlling massage units integrated in the seat based on an audio entertainment signal; and changing an intensity of the massage provided by the massage units based on the basis of the entertainment signal in a manner adapted to current operating information relating to the vehicle. A seat arrangement for a vehicle or in a vehicle for carrying out such a method is also involved.

### CROSS-REFERENCE TO RELATED APPLICATIONS

This application is the U.S. National Phase of PCT Application No. PCT/EP2017/072445, filed on Sep. 7, 2017, which claims priority to German Patent Application No. 10 2016 217 124.0, filed on Sep. 8, 2016, the disclosures of which are incorporated in their entirety by reference herein.

### FIELD OF INVENTION

The present disclosure relates to methods for controlling massage units of a massage apparatus arranged in a seat, and a seat arrangement for a vehicle or in a vehicle.

### TECHNICAL BACKGROUND

There are methods for controlling massage units in a seat which provide turning on and off or carrying out a predetermined program cycle.

### SUMMARY OF THE PRESENT INVENTION

In view of the above, one object of the present disclosure is to provide improved methods for controlling massage units of a massage apparatus arranged in a seat, and to provide a seat arrangement for a vehicle or in a vehicle.

Accordingly, the present disclosure provides:

A method for controlling massage units of a massage apparatus arranged in a seat in a vehicle for massaging an occupant, including the following method steps: controlling massage units integrated in the seat based on an audio entertainment signal; and altering an intensity of the massage provided by the massage units, based on the entertainment signal, adapted to current operating information of the vehicle.

A seat arrangement for a vehicle or in a vehicle, in particular for carrying out a method according to one or more embodiments, including a seat having a plurality of integrated massage units for massaging an occupant, a device or a connection point is provided by which the massage units are controllable based on an audio entertainment signal, adapted to current operating information relating to a vehicle, an intensity of the massage of the massage units based on the entertainment signal may be varied.

The concept based on the present invention is such that a massage based on an audio entertainment signal, e.g., a piece of music, may, in certain situations, particularly in situations which are mentally stressful for a driver or in monotonous situations, be adapted to the respective situation in terms of intensity. It is a concept of the present disclosure to alter the intensity of the massage, which is based on the entertainment signal, based on the current operating information relating to a vehicle, and adapted to the situation.

Such situations are detected on the basis of the current operating information relating to a vehicle, and the intensity of the massage based on the entertainment signal is adapted to the operating information or to the situation detected on the basis of the operating information. Thus, an intensity which is adapted to the situation is provided to the massage which is based on the entertainment signal.

Advantageously, a possible disturbance or distraction caused by the massage which is based on the entertainment signal may be reduced, thereby increasing customer satisfaction. In addition, this may, in accordance to a particular situation, provide a targeted activation or attention-grabbing for the driver.

A number of massage units may comprise one massage unit or a multitude of massage units.

A massage unit is provided in particular as a vibration element having an adjustable vibration frequency, for example in the form of an unbalance motor.

An audio entertainment signal, in particular a piece of music, may be provided or played by, for example a playback device which may be coupled to a control device for controlling the massage units. Alternatively or additionally, an audio entertainment signal for controlling the massage units may be provided in a different manner.

Current operating information relating to a vehicle may be received and processed by, for example, a control device. In particular, processing may include adjustment in accordance to predetermined threshold values. Alternatively or additionally, a control signal already derived from the operating information may be provided to the control device for adjusting the intensity of the massage.

Current operating information relating to a vehicle may in particular be provided by, for example, a vehicle bus.

Advantageous embodiments result from the disclosure set forth herein as well as from the description in combination with the figures in the drawing.

In accordance with one or more embodiments, the seat is controlled as a driver's seat, wherein the massage units are controlled for massaging a vehicle driver, and the intensity of the massage of the massage units is reduced in the event of a potentially stressful situation for the vehicle driver, which situation may be detected on the basis of current operating information. In particular, the intensity of the massage is reduced when a mentally stressful or demanding situation is detected. In this way a possible distraction for the driver or strong mental stress to which the driver is exposed and which the driver is uncomfortable with, is advantageously reduced.

The intensity of the massage is increased according to the type of massage, following a potentially stressful situation for the driver. In particular, the intensity of the massage is regulated fully automatically according to the situation. In this way the comfort is advantageously increased.

According to one embodiment, when a situation occurs, or following a situation which could potentially affect the driver, a request is made to the driver as to whether the intensity of the massage should be increased again. When the request is confirmed, the intensity of the massage is increased accordingly. In this way, the driver may determine whether the massage should be continued with the initial intensity. In addition, the driver may also overrule the reduction in intensity if, despite the potentially stressful situation, the driver wishes a more intense massage.

According to one embodiment, the current operating information includes information regarding a currently engaged gear, wherein the intensity of the massage is reduced when a reverse gear is engaged. The reduction in massage intensity may be maintained for a predetermined period of time even after shifting from reverse gear to forward gear. For example, such a predetermined period of time may be 10 to 60 seconds. This ensures that when, upon reversing and/or maneuvering, the driver will not be distracted by the massage which is based on the entertainment signal.

In another embodiment, the current operating information includes information regarding a currently set windscreen wiper level, wherein the intensity of the massage is reduced when the highest windscreen wiper level is set. In this way it is ensured that the driver is not distracted by the massage based on the entertainment signal during heavy rain.

According to one embodiment, the current operating information includes information regarding the navigation of the vehicle. For example, such information may include the history of a planned route and the current location. Alternatively or additionally, the current operational information includes information regarding current traffic messages, for example traffic messages provided by for example, a car stereo or mobile communications. Furthermore, alternatively or additionally, the current operating information includes information regarding the current surrounding of the vehicle. In particular, this refers to data or information regarding a surrounding detected by a sensor, e.g. a camera sensor and/or a radar sensor and/or an ultrasonic sensor of the vehicle. Based on the current information regarding navigation and/or current traffic messages and/or the current surrounding of the vehicle, a traffic situation requiring potentially increased attention or a situation revealing a potentially narrow or confusing lane routing is detected, and the intensity of the massage is reduced. Such a situation revealing a potentially narrow or confusing lane routing may occur at a construction site, a toll gate, or a multi-storey car park, for example. A traffic situation that possibly requires increased attention may be at a road intersection, or a turning-off or pulling-out situation, for example. In this way, the driver's attention is not distracted during such situations.

According to one embodiment, the current operating information includes information regarding a current driving condition. Alternatively or additionally, information regarding the current surrounding of the vehicle may be included. Based on the current driving condition and/or surrounding information, potentially dangerous driving maneuvers are detected, and the intensity of the massage is reduced. For example, an overtaking maneuver, avoidance maneuver or emergency braking maneuver may be detected. Driving condition information collected for this purpose may be, for example, the current engine power, a current speed, longitudinal acceleration, lateral acceleration, yaw rate and/or any slip or information from an electronic stability program (ESP), an anti-slip control (ASR) and/or an anti-lock braking system (ABS). Current surrounding information may include, in particular, a distance, detected by a sensor, to a vehicle in front or driving alongside, or information from a distance control system, often referred to as Active Cruise Control (ACC). In this way, the alertness of the driver is not distracted during such maneuvers.

According to one embodiment, the current operating information includes information regarding a current operating behavior during operation of the vehicle, wherein the information regarding the operating behavior is used to identify a situation with potential distraction of the driver and to reduce the intensity of the massage. In particular, such a situation with potential distraction may for instance be when the driver is making an active telephone call or is actively making an input on the on-board computer, navigation device or telephone. It may also be that the driver is using a voice control, or the driver is retrieving information regarding traffic messages or news, or the like. In this way, the driver is advantageously adapted to the situation and will not, on top of his actions, be distracted by the massage based on the entertainment signal.

According to one embodiment, upon reduction of the intensity, the massage of the massage units is maintained at a reduced intensity level. In this way, the driver is able to see that the massage is only maintained at a lower intensity level and that there is no malfunction or unwanted deactivation. In the case of another type of massage, the intensity of the massage units is reduced to zero, thereby interrupting or ending the massage.

In particular, different types of incidents or situations causing the occurrence of a reduction may provide for different ways of reducing the intensity level. For example, only temporary situations/incidents, such as shifting into reverse gear, may cause only a reduction in intensity, while upon normally occurring situations/incidents, such as setting a maximum wiper level, may cause an interruption or turning off. Thus, operating the massage system is more intuitive to the user which is therefore an improvement.

According to an exemplary embodiment, the reduction of the massage intensity of the massage units is carried out by slowly decreasing the intensity. In addition, a subsequent increase in intensity may be carried out by slowly increasing the intensity again. This creates a transition that is perceived as comfortable when the intensity changes. In particular, the slow decrease takes place with steadily decreasing intensity, over a predetermined period of time, e.g. several seconds, for example.

According to a further embodiment, the current operational information includes information regarding the status of a hazard warning system. If a hazard warning occurs, the intensity of the massage of the massage units is suddenly reduced. In this way, the driver's attention may be immediately drawn to the hazardous situation. The hazard warning system may in particular be a lane departure warning and/or collision warning and/or emergency brake assistant or the like. In particular, the sudden reduction in intensity makes the driver additionally aware of the hazard warning. In particular, it is possible to use a habituation effect previously experienced during a prolonged massage to use the change in order to increase alertness by suddenly or abruptly reducing the intensity of the massage.

According to one embodiment, the seat is controlled as a driver's seat, wherein the massage units are controlled for the massage of a vehicle driver, and the intensity of the massage of the massage units is increased in the event of a monotonous and/or fatigue-inducing situation for the vehicle driver which is detectable on the basis of the current operating information. In this way, the degree of alertness or the attention of the driver may be maintained advantageously. In particular, the driver is stimulated or activated with increased intensity by the massage based on the entertainment signal.

According to a further embodiment, the current operating information may include information regarding the navigation of the vehicle and/or regarding current traffic messages and/or regarding the current surrounding of the vehicle, wherein a monotonous and/or fatigue-promoting situation is being detected on the basis of the current information regarding the navigation and/or regarding current traffic messages and/or regarding the current surrounding of the vehicle, thus increasing the intensity of the massage. An example of a fatigue-promoting situation may be when the driver drives straight on for long stretches of the road, driving on a motorway with light traffic, or driving during night times.

According to one embodiment of a seat arrangement, the seat forms a driver's seat, wherein the massage units are provided for the massage of a vehicle driver and wherein the intensity of the massage of the massage units may be reduced upon occurrence of a situation which is detectable on the basis of the current operating information being potentially stressful for the vehicle driver. Such a potentially stressful situation may exist, as set out above with respect to a method for controlling massage units, in particular when engaging a reverse gear and/or engaging the highest windscreen wiper level and/or detecting a crossing, turning or threading situation, and/or detecting a situation with potentially confusing, narrow or dangerous driving lane, and/or detecting a situation with potential distraction for the driver. Alternatively or additionally, according to one embodiment, the intensity of the massage of the massage units may be increased when a situation occurs which is monotonous or fatigue-promoting for the driver, the situation being detectable on the basis of the current operating information. For example, this may be the case when the driver drives straight on for long stretches of the road, driving on a motorway with light traffic, or driving during night times.

The above embodiments may be combined with each other in any sensible manner. In particular, all the features and functions described in relation to the method of controlling massage units may be adapted for a seat arrangement for a vehicle or in a vehicle. In particular, a control device may be provided which is configured for the respective control.

Further possible embodiments of the present invention also include combinations of features of the present invention described before or in the following with regard to the exemplary embodiments, which are not explicitly mentioned. In particular, the skilled person will add individual aspects as improvements or additions to the respective basic embodiment of the present invention.

### BRIEF DESCRIPTION OF THE DRAWINGS

The present invention will be explained in more detail below using the examples given in the schematic figures of the drawing, wherein:

FIG. 1 shows a block diagram of an embodiment of a seat arrangement in a motor vehicle;

FIG. 2 shows a seat arrangement in a motor vehicle according to a further embodiment;

FIG. 3 shows a seat arrangement according to FIG. 1 or 2 comprising an input/output device;

FIG. 4 shows a flow chart of a method for controlling massage units in a seat.

The enclosed figures in the drawing are intended to provide a further understanding of the embodiments in which the invention was carried out. They illustrate exemplary embodiments and help, in connection with the description, to explain the principles and concepts of the present invention. Further embodiments and many of the advantages mentioned result from the drawings. The elements of the drawings are not necessarily drawn to scale.

In the figures of the drawing, like elements, features and components having the same function and effect are indicated by the same reference signs, unless otherwise specified.

### DESCRIPTION OF THE EMBODIMENTS

Document DE 297 05530 U1 discloses a vehicle seat in which oscillating heads are integrated whose drive frequency may be adjusted in different stages or continuously variable by a corresponding user input. Such a control, however, only provides monotonous massage cycles.

Document DE 43 31 663 C1 discloses a control device which jointly controls the position-adjusting and contour-adjusting means of a vehicle seat. The control device includes a memory unit in which control programs for these means may be stored. The contour adjustment means are simultaneously activated jointly by the control device in a predeterminable chronological sequence for causing activation of a massage and gymnastics program. However, it is a disadvantageous that such programs become known to a user in a relatively short period of time.

It is currently envisaged to couple massage systems in a vehicle with other vehicle systems to improve a driver's experience. Such a concept is disclosed e.g. in document DE 10 2015 109067 A1, according to which a vibration of the massage system of a vehicle seat is used for intensification/enhancement of music, the vehicle engine, or for situation warning. In such systems, vibration is therefore always used to intensify a stimulus, which may result in a large number of strong stimuli acting on a driver.

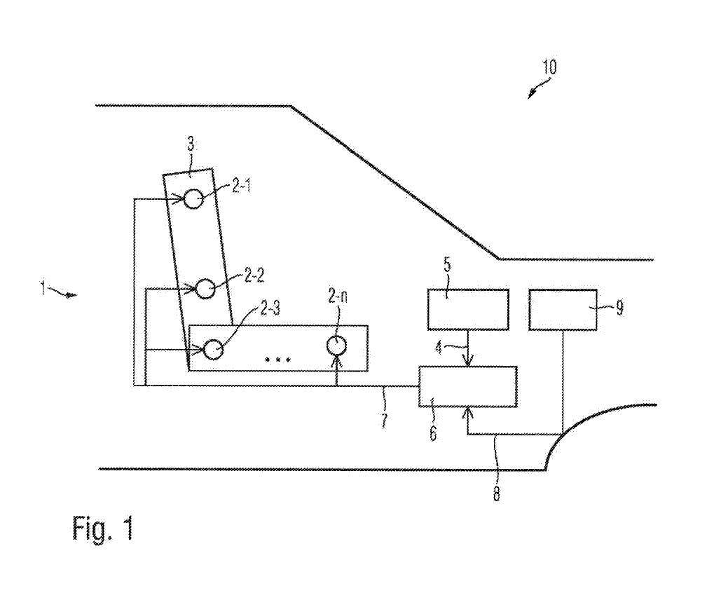

FIG. 1 shows a block diagram of an embodiment of a seat arrangement 1 in a motor vehicle 10.

The motor vehicle 10 is indicated here schematically as a section thereof. The seat arrangement 1 is arranged within the motor vehicle 10 accordingly.

The seat arrangement 1 may include a vehicle seat 3, which is in particular a driver's seat, as well as a number of, i.e. one or more, massage units 2-1 to 2-n, in this example four. In FIG. 1 only the massage units 2-1 and 2-2 in the back rest, and the massage units 2-3 and 2-n in the seating are arranged, as an example. Further massage units are indicated by three dots. The number and arrangement of the massage units may be varied.

To control the massage units 2-1 to 2-n, a controller 6 is provided, which generates a control signal 7 for the massage units 2-1 to 2-n from an audio entertainment signal 4 provided by a playback device 5, the signals being transmitted to the units.

The audio entertainment signal 4 may be, for example, an audio signal representing a piece of music or the like. The entertainment signal 4 may be provided by different sources. For example, the playback device 5 may be an audio entertainment system installed in a vehicle, e.g. comprising a stereo, CD player, DVD player, Blu-ray player, and/or MP3 source. However, the playback device 5 may also be the audio system, which receives the entertainment signal 4 by for example, Bluetooth from a smartphone. Other embodiments may also comprise a signal from a video clip, film, game console or the like.

In particular, controller 6 and playback device 5 may also be combined or integrated into a single device. For example, controller 6 may already be integrated in the vehicle's audio system. In one embodiment, the massage units 2-1 to 2-n are directly coupled to the playback device 5, the playback device 5 comprising the necessary control circuit for providing the output signal 7. Both the playback device 5 and the controller 6 may be at least partially configured as computer program modules which are executed by a computing device of the audio system.

In a further embodiment, the controller 6 may also be, for example, an external computing device with a corresponding computer program module or a control unit which provides suitable control signals to the individual massage units 2-1 to 2-n. The computing device may, for example, be a vehicular module, in particular a body control module.

The controller 6 is also coupled to a vehicle component 9. The vehicle component 9 is formed as a data processing vehicle component and provides operating information 8 regarding the vehicle 10 to the controller 6. The current operating information 8 of vehicle 10 may, for example, be transmitted by a vehicle bus to controller 6.

The operational information provided may be a wide variety of information processed in the vehicle, which could indicate the occurrence of a potentially mentally stressful or monotonous or fatigue-promoting situation for a driver.

For example, vehicle component 9 is coupled to a transmission or gear selector (not shown), and provides information to controller 6 on a currently engaged gear of vehicle 10.

For example, vehicle component 9 is further coupled to a windscreen wiper control (not shown) or a windscreen wiper selector (not shown), and provides the controller 6 with information regarding a current windscreen wiper level of vehicle 10.

The operational information 8 provided is not limited thereto but may contain a variety of further information or data, which will be discussed in more detail with respect to the other figures.

The controller 6 controls the massage units 2-1 to 2-nin order to operate with a predetermined intensity, wherein the predetermined intensity may be adjusted by a user.

The controller 6 is also configured to change the intensity of the massage according to the situation and the operating information 8.

For example, the controller 6 reduces the intensity of the massage when reverse gear is engaged on the vehicle 10. In this way, a driver may concentrate on maneuvering in reverse, and is not distracted by the massage which is based on the entertainment signal. When a forward gear is engaged, the intensity of the massage, which is based on the entertainment signal, is then raised back to the level which was set before shifting into reverse gear.

In addition, the control device reduces the intensity of the massage, for example when the highest windscreen wiper level is set in the vehicle, or when the vehicle's selection device is used. In this way, a driver may focus on driving the vehicle during heavy rainfall without being distracted by the massage.

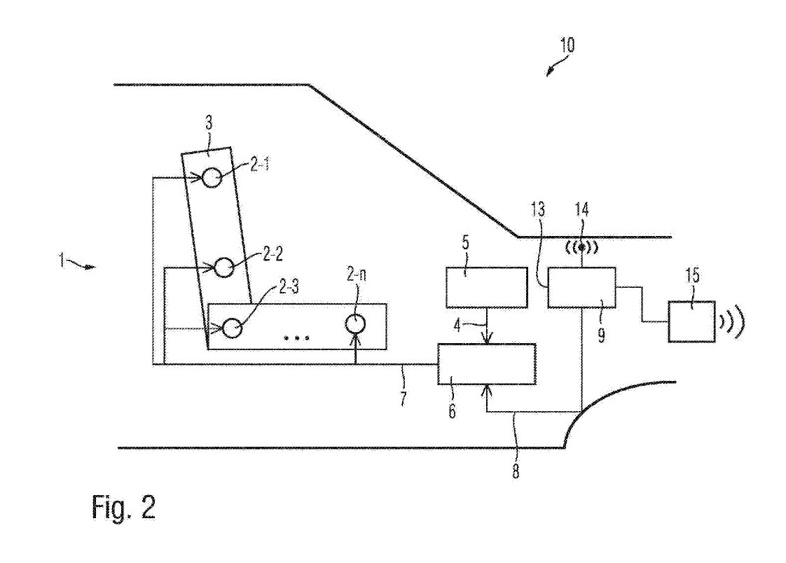

FIG. 2 shows a seat arrangement 1 in a motor vehicle 10 according to a further embodiment.

With this embodiment, the vehicle component 9 is configured as a control unit 13 of the vehicle 10. The control unit 13 is coupled to a wide variety of receiving devices and sensors of the vehicle 10, in this example indicated by an antenna 14, which may include a GPS device, stereo and/or mobile communications antenna, as well as an environmental sensor 15, which may comprise an ultrasonic sensor, radar sensor and/or visual sensor.

In addition, other sensors (not shown), in particular acceleration or slip sensors, may be coupled to the control unit 13.

In addition, an engine control unit (not shown) may be coupled with the control unit 13 such that all engine information, in particular the engine power currently demanded, may be transmitted to the control unit 13.

By means of the receiving devices, the control unit 13 receives navigation information, for example by means of a GPS device, as well as current traffic information, for example by means of a stereo or mobile communications device.

By means of the environmental sensor 15, the control unit 13 detects the surrounding of the vehicle 10, in particular distances to other vehicles or to a road boundary and, where appropriate, visibility conditions. It also includes a driving condition of the vehicle, such as longitudinal or lateral acceleration, slip rates, or the like.

The information thus obtained is transmitted by the control unit 13 to the controller 6 in the form of operating information 8.

In one embodiment, the controller 6 together with the control unit 13 may also be configured as a software module on a common computing device, e.g. a body control module.

The operating information 8 provided in this way by the control unit 13 for the controller 6 is used by the controller 6 for the situation-adaptive variation of the massage intensity of the massage units 2-1 to 2-n in the seat 3.

For example, the controller 6 is configured to detect a traffic situation requiring increased attention on the basis of current information regarding navigation and current traffic messages as well as regarding the current surrounding of the vehicle. Based on the same or further operating information, a situation revealing a potentially narrow or confusing driving lane may also be detected.

When such a situation is detected, the controller 6 changes the output signal 7 so as to reduce the intensity of the massage of the massage units 2-1 to 2-n based on the audio entertainment signal 4.

In addition, the controller 6, for example, is configured to detect potentially dangerous driving maneuvers on the basis of current driving status information and information regarding the surrounding. For example, a potentially dangerous overtaking maneuver may be derived from information regarding acceleration together with engine performance information and simultaneous information regarding a relatively short distance to another vehicle. In addition, a potentially dangerous avoidance maneuver may be derived from information regarding the angular speed at a steering angle and regarding the lateral acceleration of the vehicle. Furthermore, an emergency braking maneuver may be derived from a very high negative longitudinal acceleration value.

When such potentially dangerous driving maneuvers are detected, the controller 6 also changes the output signal 7 in such a way that the intensity of the massage is reduced. Thus, the full alertness or attention of the driver may be available in order to handle the situation or the driving maneuver.

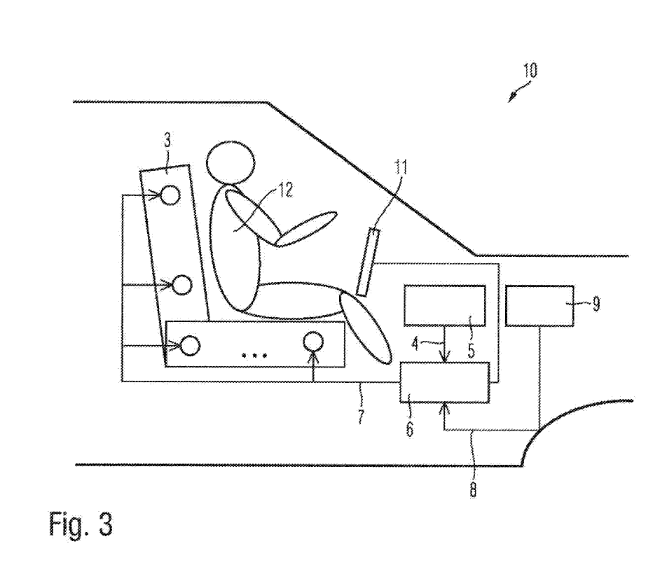

FIG. 3 shows a seat arrangement according to FIG. 1 or 2 comprising an input/output device.

For example, input/output device 11 is configured as a human-machine interface of vehicle 10 coupled to vehicle component 9. In this way, the vehicle component 9 receives information regarding the current operating behavior upon operation of the vehicle 10, providing the information to the controller 6. The controller 6 is configured to detect a situation with potential distraction for the driver by means of the information regarding the operating behavior.

For example, the controller 6 may detect an active telephone call or an active input on the on-board computer, navigation device, or telephone, and may then change the output signal 7 in such a way that the intensity of the massage is reduced. In this way, the driver, who is already potentially distracted by the operation, will not be distracted additionally by the massage based on the entertainment signal.

In addition, a communication the other way round may also be provided between controller 6, vehicle component 9, and input/output device 11. For example, the controller 6 is configured, following a potentially stressful situation for the driver, to carry out, by means of the input/output device 11, a request directed to the driver 12 as to whether the intensity of the massage should be increased again. By confirming the request, the driver 12 may thus cause the controller 6 to change the output signal 7 again in such a way that the intensity of the massage is increased.

FIG. 4 shows a flow chart of a method for controlling massage units 2-1 to 2-n in a seat 3.

The seat 3 may in particular be a vehicle seat 3, such as a driver's seat.

The method provides a step of playing back, S1, an audio entertainment signal 4. However, the step S1 is optional and may be replaced, for example by receiving an audio entertainment signal provided elsewhere 4.

The method also provides a step of controlling, S2, massage units 2-1 to 2-n integrated in the seat 3, based on the audio entertainment signal 4.

In addition, the method provides a step of receiving and processing, S3, current operating information 8 of a vehicle. However, the step S3 is optional and may also be replaced, for example by providing a control specification that has already been derived from the operational information.

In addition, the method provides a step of altering, S4, an intensity level of the massage based on the entertainment signal 4 of the massage units 2-1 to 2-n, adapted to the current operating information 8.

The audio entertainment signal 4 may, for example, be a piece of music which is played back S1 by means of a playback device 5. The audio entertainment signal 4 may, alternatively or in addition to the step of playing back S1, also be provided to the playback device 5 by means of an audio signal source. The audio signal source may in particular be a mobile audio signal source, such as a smartphone or the like, a receiver, such as a radio receiver or the like, or a vehicle-internal audio signal source, such as a player for playing a storage medium, such as a CD, a mass storage medium or the like.

Particularly in the case of a vehicle seat, i.e. when applying the method to a vehicle 10, the playback device 5 may be an entertainment system of the respective vehicle 10 or may be coupled to it.

The step of controlling S2 of the massage units 2-1 to 2-n may be carried out, for example, by means of a pulse-width modulated output signal 7. For this purpose, the audio entertainment signal 4 may be converted into a sequence of corresponding pulses by the controller 6.

The steps of receiving and processing S3 of current operating information 8 is achieved in particular by coupling controller 6 with operating information 8 of vehicle component 9, such as a control unit 13. The step of processing may be performed either by detecting a predetermined signal, such as when a reverse gear is engaged, or by detecting a situation by deriving a signal strength, such as an amount of the engine power currently requested, and/or by matching with a predetermined threshold value. In addition, situation patterns stored in databases of the control device may be matched with combinations of a series of operational information 8 provided or signals, for example to a combination of specific information regarding navigation, traffic, and surrounding.

Upon the step of altering S4 the intensity of the massage based on the entertainment signal of the massage units 2-1 to 2-n, the controller 6 adjusts in particular a level of the output signal 7. For example, in order to reduce the intensity of the massage, the level of the output signal 7 is reduced, and in order to increase the intensity, the level is increased.

In one embodiment, the audio entertainment signal 4 may be adjusted depending on the output volume of the playback device 5. The output volume according to this embodiment therefore determines the strength of the vibrations. Likewise, the output volume of the output device 5 may also be adapted by adjusting the intensity of the massage, especially by means of the controller 6.

The massage intensity of massage units 2-1 to 2-n is reduced when a potentially stressful situation for the driver is identified on the basis of operating information 8.

Following the situation being potentially stressful for the driver, the intensity of the massage may be automatically increased again according to one embodiment. Alternatively or additionally, the driver 12 may be requested, in particular by means of an input/output device 11, as to whether the intensity of the massage should be increased again. In particular, a default setting, for example in the menu control of an on-board computer of vehicle 10, may be provided to set defaults for the request or to turn off the request.

In particular, the request may be carried out before or after the situation which potentially stresses the driver. If the driver confirms the request, in particular by means of the input/output device, the intensity of the massage is increased again accordingly.

In addition, further options may be set for controlling the reduction and/or increase in intensity of the massage of the massage units 2-1 to 2-n. For example, according to a possible setting, if the massage intensity of massage units 2-1 to 2-n is reduced, the massage will continue with a reduced intensity level.

An alternative setting is such that, upon reducing the intensity of the massage, to reduce the intensity to zero, such that the massage is interrupted or stopped.

Another setting is such that, in order to reduce the intensity of the massage of the massage units 2-1 to 2-n, the intensity will be decreased slowly.

In particular, these settings may be determined individually for different situations which have been detected and which may be potentially stressful for the driver.

If the vehicle component 9 includes a hazard warning system, the intensity of the massage of the massage units 2-1 to 2-n may be abruptly reduced upon occurrence of a hazard warning, regardless of the setting. In this way, the sudden reduction in intensity will attract the attention of the driver.

According to a further embodiment, a change in intensity based on the operating information 8 may also consist in increasing the massage intensity level of massage units 2-1 to 2-n upon occurrence of a situation which is detectable through the operating information 8 and which is monotonous and/or fatigue-inducing for the driver 12.

Although the present invention has been fully described above using preferred exemplary embodiments, the present invention is not limited thereto, but may be modified in numerous ways.

### LIST OF REFERENCE SIGNS

1 Seat arrangement
2-1 to 2-n Massage units
3 Seat
4 Audio entertainment signal
5 Playback device
6 Controller
7 Output signal
8 Vehicle information
9 Vehicle component
10 Vehicle
11 Input/output device
12 Driver
13 Control unit
14 Antenna
15 Environmental sensor

1. A method of controlling massage units of a massage apparatus, arranged in a seat for use in a vehicle, configured to massage an occupant, the method comprising:
controlling massage units integrated in the seat based on an audio entertainment signal; and
altering an intensity of the massage provided by the massage units, based on the audio entertainment signal, adapted to current operating information of the vehicle.

2. The method of claim 1,
wherein the seat is a driver's seat and the massage units are configured to massage a vehicle driver, and wherein the intensity of the massage provided by the massage units is reduced in response to an occurrence of an event based on the current operating information and wherein the event is potentially stressful for the vehicle driver.

3. The method of claim 2,
wherein the intensity of the massage is increased again following a situation which is potentially stressful for the vehicle driver.

4. The method of claim 2,
wherein if a situation occurs which is potentially stressful for the vehicle driver, or following the situation which is potentially stressful for the vehicle driver, a request is made to the vehicle driver as to whether the intensity of the massage is to be increased again, and in response to a confirmation of the request, increasing the intensity of the massage.

5. The method of claim 1, wherein the current operating information includes information regarding a gear currently engaged, the intensity of the massage being reduced when a reverse gear is engaged.

6. The method of claim 1 wherein the current operating information includes information regarding a windscreen wiper level which is currently set, the intensity of the massage being reduced when the highest windscreen wiper level is set.

7. The method of claim 1, wherein the current operating information includes navigation information of the vehicle and/or regarding current traffic messages and/or regarding a surrounding of the vehicle, including being detected by a sensor, wherein a traffic situation which potentially requires increased attention or a situation including a potentially narrow or unclear lane being based on the navigation information and/or for current traffic messages and/or for the current surrounding of the vehicle and the intensity of the massage being reduced.

8. The method of claim 1, wherein the current operating information includes information relating to a current driving state and/or to a current surrounding of the vehicle, a potentially dangerous driving maneuver, including an overtaking, evasive or emergency braking maneuver, being detected using the current driving state and/or surrounding information, and the intensity of the massage being reduced.

9. The method of claim 1, wherein the current operating information includes information regarding an operating behavior when operating the vehicle, including a situation with potential distraction of a vehicle driver based on the information regarding the operating behavior.

10. The method of claim 1, wherein when the intensity is reduced, the massage of the massage units is continued with reduced intensity or the intensity is reduced to zero and the massage is interrupted or terminated.

11. The method of claim 10, wherein reducing the intensity of the massage of the massage units is performed with a slow drop in intensity.

12. The method of claim 1, wherein the current operating information includes information regarding a status of a hazard warning system and, if a hazard warning occurs, the intensity of the massage of the massage units is reduced.

13. The method of claim 1,
wherein the seat is actuated as a driver's seat, the massage units being actuated to massage a vehicle driver and the intensity of the massage of the massage units being increased in the event of a situation based on the current operating information and which is monotonous and/or promotes fatigue for the vehicle driver.

14. A seat arrangement for use in a vehicle, configured to perform the method of claim 1, the seat arrangement comprising:
a seat having a plurality of integrated massage units configured to massage an occupant; and
a device or a connection point configured to control the massage units based on an audio entertainment signal, and wherein the device or a connection point are each configured to vary an intensity of the massage of the massage units based on the current operating information of a vehicle and the entertainment signal.

15. The seat arrangement of claim 14,
wherein the seat forms a driver's seat and the massage units are configured to provide a massage to a vehicle driver, and wherein an intensity of the massage being reducible when a situation which may be detected on the basis of the current operating information and is potentially stressful for the vehicle driver occurs and/or may be increased when a situation based on the current operating information is monotonous and/or promotes fatigue for the vehicle driver occurs.

16. A vehicle seat for use in a vehicle, the vehicle seat comprising:
a massage unit configured to massage an occupant seated in the vehicle seat;
a controller configured to:
alter an intensity of the massage, in response to an audio entertainment signal,
reduce the intensity of the massage, in response to receiving signals indicative of a predetermined vehicle event, and
increase the intensity of the massage, in response to receiving signals indicative of termination of the predetermined vehicle event.

17. The vehicle seat of claim 16, wherein the controller is further configured to prompt the occupant to increase the intensity of the massage and upon receiving an affirmative response, increase the intensity of the massage.

18. The vehicle seat of claim 16, wherein the predetermined vehicle event includes an evasive maneuver.

19. The vehicle seat of claim 16, wherein the controller is further configured to reduce the intensity of the massage in response to engagement of a reverse gear of the vehicle.

20. A method of controlling massage units arranged in a vehicle seat, the method comprising:
altering an intensity of the massage units, based on an audio entertainment signal;
reducing the intensity of the massage units, in response to receiving signals indicative of a predetermined vehicle event; and
increasing the intensity of the massage units, in response to receiving signals indicative of termination of the predetermined vehicle event.
